(19) United States
(12) Patent Application Publication
(10) Pub. No.: US 2003/0157919 A1
(43) Pub. Date: Aug. 21, 2003

(54) Battery Module with Wireless Receiver built in to power Distributed Sound System

(76) Inventors: Ib Ingermann Olsen, New York, NY (US); Christopher Breckenridge Todd, New York, NY (US); Nicholas B. Pasquale, Somers, NY (US)

Correspondence Address: JEFFREY FURR, 253 N. MAIN STREET, JOHNSTOWN, OH, 43031, US

(21) Appl. No.: 10/248,797

(22) Filed: Feb. 19, 2003

Related U.S. Application Data
(60) Provisional application No. 60/358,428, filed on Feb. 20, 2002.

(51) Int. Cl. H04B 1/16

(52) U.S. Cl. 455/343

(57) ABSTRACT

The invention comprises a battery module with wireless receiver built in to power a speaker which allows for a flexible and cost saving sound system. The invention allows for distributed, local sound sources without having to use wires to provide signal and electricity. It can be used in multiples to form a complete system and is independent of local power availability.

### CROSS REFERENCE TO RELATED APPLICATIONS

This patent claims a priority date of Provisional Patent 60/358,428 dated Feb. 20, 2002.

### Copyright Statement

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

This invention relates to wireless devices, in particular sound system devices.

1. Background

Conventional sound systems consist of a powered speaker, which needs electrical wires to provide electricity and another set of wires to provide the electrical signal. When several speakers are necessary, significant time and effort must be used to string out the wires from the electrical outlet and from the sound source to the individual speakers. Often the wires must be hidden for cosmetic or safety reason, which adds complexity and increases the set-up and tear down time.

Often sound systems are installed to be used in events lasting only a few hours, after which they are taken down again. On other occasions the sound system is removed every day for security reasons. In either case significant time and resources are used to install and disassemble the sound system, which are costly and have a significant chance of malfunction.

In certain circumstances the number of speakers will be limited by the availability of power on the location, as electrical outlets or electrical generators are only rated to a certain current before a fuse will trip and shut off the power.

2. Prior Art

There exist battery powered wireless speakers such as the Liberty portable sound system sold by Anchor Audio, Torrance, Calif. However these solutions can not be used with the high quality speakers and wireless components made for fixed wire and powered applications, and can therefore not ensure the same high quality sound experience The need for a sound system that require less time and resources to install and disassemble shows that there is still room for improvement in the art.

### SUMMARY OF INVENTION

The present invention relates to a sound system that requires less time and resources to install and disassemble.

It is the object of the present invention to provide a sound system that requires less time to install. It is another object of the present invention to provide a sound system that has its own power source, which can power equipment which would normally not be considered to be independent of outlets or generators. The invention comprises a battery module with wireless receiver built in to power a speaker which allows for a flexible and cost saving sound system.

The present invention uses high quality speakers and wireless components made for fixed wire and powered applications, and can therefore ensure a high quality sound experience.

The present invention allows for distributed, local sound sources without having to use wires to provide signal and electricity. It can be used in multiples to form a complete system and is independent of local power availability.

The invention avoids the use of wires needed to provide power and signal to the distributed loudspeakers. This reduces the time and complexity needed to set-up and disassemble the sound system, which will provide a significant cost reduction. It will also increase the flexibility of the sound system, as it will not restrict the placement of speakers to where power can be provided, and the number of speakers is not dependent on local power availability.

### BRIEF DESCRIPTION OF DRAWINGS

Without restricting the full scope of this invention, the preferred form of this invention is illustrated in the following drawings:

FIG. 1 Audio control system transmission side;

FIG. 2 Group of self-powered speakers powered by a battery driven module with built in wireless receiver;

FIG. 3 Power and signal module powering a self-powered speaker; and

FIG. 4 Power ad signal module with a signal delay and distance detector.

### DETAILED DESCRIPTION

The following description of a sound system device is demonstrative in nature and is not intended to limit the scope of the invention or its application of uses.

There are a number of significant design features and improvements incorporated within the invention.

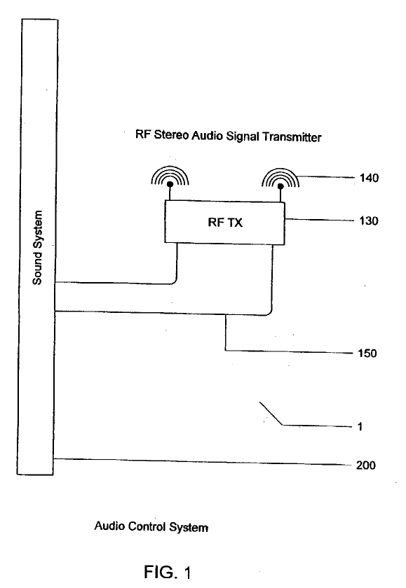

As shown in FIG. 1, the current invention has a sound system 200, which can be any audio generating device which generateds an audio signal 150. This audio signal 150 is sent to an RF Transmittor 130 and converted to an RF signal 40. This RF signal 40 is broadcasted out to the speakers 100.

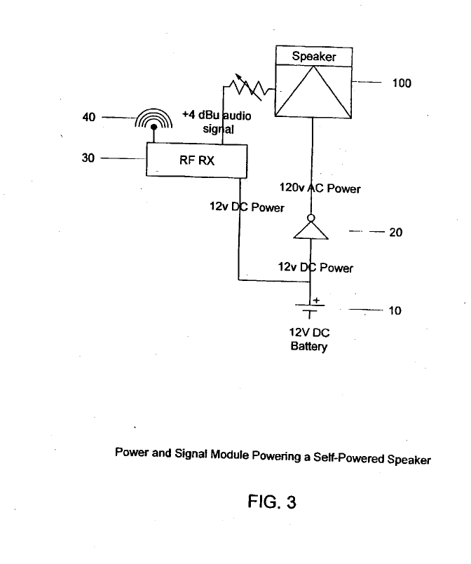

As shown in FIG. 3, the receiving part of the device 1 made up of an electrochemical storage device 10, a electrical power conditioner such as a DC to AC inverter 20 that controls the power from the electrical storage device 10, and a wireless receiver 30 that transforms the wireless signal 40 to an audio signal 50. This module 1 can be interfaced with a powered speaker 100 to provide both power and audio signal 50. In the preferred embodiment, the device 1 will be located in close proximity to the powered speaker 100 so no extensive wires are needed. The wireless receiver 30 receives the RF signal 40 transmitted by the RF transmitter 130.

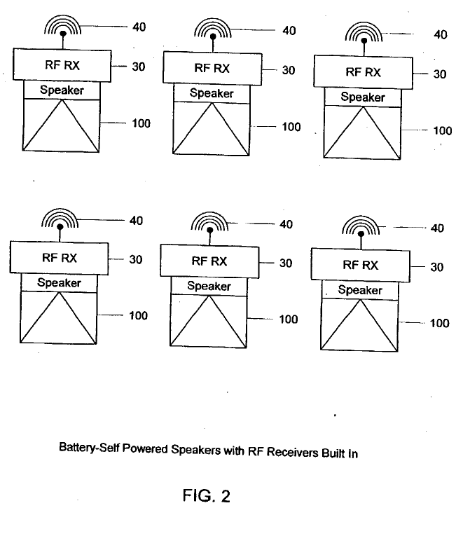

As shown in FIG. 2, each module can receive the signal from the broadcast transmitter 70 and pass it on to the self-powered speaker 100. The invention avoids the use of wires needed to provide power and signal to the distributed speakers 100. This reduces the time and complexity needed to set-up and disassemble the sound system 200, which will provide a significant cost reduction. It will also increase the flexibility of the sound system 1, as it will not restrict the placement of speakers 100 to where power can be provided, and the number of speakers is not dependent on local power availability.

As shown in FIG. 3, the power to the speaker 100 comes from the module's inverter 70, which again is supplied by the energy storage device 10. The energy storage device 10 is also providing the power to the wireless receiver 30 either through an inverter 20 or directly from the storage device 10.

The electrochemical device 10, in the preferred embodiment, is a secondary, rechargeable battery including but not limited to the following technologies: Lead-acid, Nickel Cadmium, Nickel Metal Hydride, Nickel Zinc, Lithium, and Lithium-ion. The electrical storage device can also be a primary battery such as Alkaline batteries. In another embodiment the electrochemical device is a fuel-cell powered by metal or by hydrogen, methanol, methane, or another hydrogen containing substance. In case a rechargeable battery is used it can be recharged using a compatible battery charger. In case a fuel-cell is used the unit can be refueled using a suitable fuel. In order to prolong the operation life multiple modules of electrochemical storage devices can be placed in parallel.

The electrical power conditioner such as an inverter 20 controls the power delivered by the electrochemical storage device 10 and transform it into a quality of power suitable for the speaker 100. This can involve regulating the voltage and/or transform it from direct current to alternating current using a voltage regulator which is well know in the art and therefore not gone into detail here. Typically the electrical power conditioner 20 will also provide additional safety functions such as over-current protection.

As signal quality is very important special care is also taken to include any electrical filters and grounding necessary to provide electrical power of good quality.

The wireless receiver 30 can be based on an analog or digital technology or a combination thereof. In the preferred embodiment, it will take a wireless signal 40 and transform it to a fixed gain audio input 50 for the speaker 100. It may incorporate a manual volume gain control, so the volume can be adjusted locally. The wireless audio signal may also incorporate a volume level signal to remotely adjust the volume of all or a specific speaker 100.

In the preferred embodiment, the invention uses high quality speakers 100 and wireless components 30 that are made for fixed wire and powered applications, and therefore ensure the same high quality sound experience as possible with none wireless speakers 100.

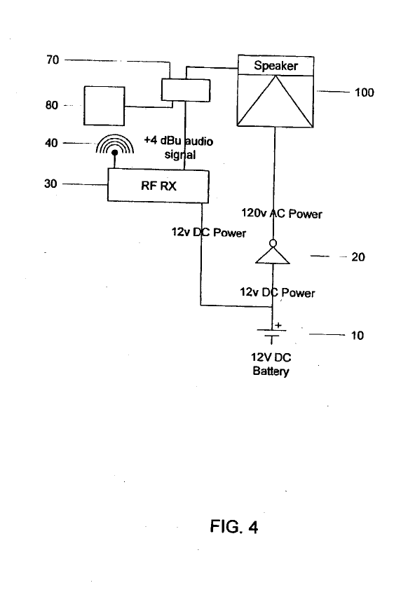

As shown in FIG. 4, the device 1 can have a build-in adjustable signal delay 70 to compensate for the distance between the source of the sound such as a band and the speaker 100 powered by the battery unit 20. The battery unit 20 may also have a build-in distance measurement device 80 to determine the above distance.

In one preferred embodiment the wireless receiver 30 is modular allowing different brands can be used to use existing infrastructure. This will allow the use of multiple power modules with one wireless module and thereby reduce the overall cost.

Operation

The device 1 can be demonstrated using a Trojan 12V lead acid battery 10, Galaxy 700W/1400W peak inverter 20, and a Sennheizer SK300 IEM receiver wireless system 30. The components were integrated in a portable module and used to power a Meyer Sound UPM-1P powered speaker 100. The fully charged power module could provide electricity and sound signal to the powered speaker 100 for 5 hrs when the powered speaker was operated at maximum volume. When the speaker 100 is operated at a level suitable for normal operation, the fully charged power module 10 could provide electricity in excess of 10 hours.

Advantages

The previously described version of the present invention has many advantages, including many elements missing in all prior art.

The present invention provides a sound system that requires less time to install. It provides a sound system that has its own power source. The current invention allows for a flexible and cost saving sound system. It allows for a distributed, local sound source without having to use wires to provide signal and electricity. It can be used in multiples to form a complete system and is independent of local power availability.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed. Therefore, the point and scope of the appended claims should not be limited to the description of the preferred versions contained herein.

That which is claimed is:

1. A device comprising: (a) a plurality of speakers;
(b) which are attached to a power storage device;
(c) and are attached to a wireless receiver; and
(d) which received signals from a wireless transmitter.

2. A device as in claim 1 where said wireless transmitter transmits an audio signal.

3. A device as in claim 1 where said wireless transmitter receives an audio signal from a sound system.

4. A device as in claim 1 where said power storage device has an inverter.

5. A device as in claim 1 where said power storage device has an inverter that controls the power delivered by the power storage device and transforms it to a power suitable for speaker.

6. A device as in claim 1 where said wireless receiver receives a wireless signal from a wireless transmitter and converts the wireless signal to an audio signal, said audio signal going to said speaker.

7. A device as in claim 1 where said power storage device is a rechargeable battery.

8. A device as in claim 1 where said device has a signal delay.

9. A device as in claim 1 where said device has a distance measuring component.

10. A method for a wireless sound system comprising the steps of: having a
plurality of speakers which are attached to a power storage device;
having a wireless receiver attached to said speaker; and
having a wireless transmitter transmitting a signal to said wireless receiver.

11. A method as in claim 10 which has the additional step of having said wireless transmitter transmits an audio signal.

12. A method as in claim 10 which has the step of receving an audio signal being received from a sound system.

13. A method as in claim 10 having said an inverter attached to said power storage device.

14. A method as in claim 10 which includes the steps of having said power storage device having an inverter that controls the power delivered by the power storage device and transforming it to a power suitable for speaker.

15. A method as in claim 10 which includes the step of having said wireless receiver receiving a wireless signal from a wireless transmitter and converting the wireless signal to an audio signal, with said audio signal going to said speaker.

16. A method as in claim 10 where said power storage device is a rechargeable battery.

17. A method as in claim 10 which includes the step of having a signal delay.

18. A method as in claim 10 which includes the step of having a distance measuring component.

19. A method as in claim 10 which includes the steps of having a distance measuring component, having a signal delay and delaying said signal based on the information from the distance measuring component.
